(19) United States
(12) Patent Application Publication
(10) Pub. No.: US 2016/0371025 A1
(43) Pub. Date: Dec. 22, 2016

(54) MEMORY SYSTEM AND OPERATING METHOD THEREOF

(71) Applicants: SK hynix Inc., Gyeonggi-do (KR); SHINSUNG International Patent & Law Firm, Seoul (KR)

(72) Inventors: Sang-Jun PARK, Gyeonggi-do (KR); Do-Young JOO, Gyeonggi-do (KR); Jong-Bae JEONG, Seoul (KR)

(21) Appl. No.: 14/958,581

(22) Filed: Dec. 3, 2015

(30) Foreign Application Priority Data
Jun. 17, 2015 (KR) 10-2015-0085778

(51) Int. Cl. G06F 3/06

(52) U.S. Cl. CPC G06F 3/0619; G06F 3/065; G06F 3/0659; G06F 3/0685

(57) ABSTRACT

A memory system may include a memory device including a plurality of planes each including a plurality of memory blocks; and a controller suitable for storing first and second command data corresponding to first and second commands in a first and a second sub-buffer of a buffer or one or more extra page buffers among page buffers included in the plurality of planes, respectively, according to a priority information and a size information of the first and second commands, and performing first and second command operations in response to the first and second commands, respectively.

### CROSS-REFERENCE TO RELATED APPLICATIONS

The present application claims priority of Korean Patent Application No. 10-2015-0085778, filed on Jun. 17, 2015, which is incorporated herein by reference in its entirety.

### BACKGROUND

1. Field

Exemplary embodiments of the present invention relate to a memory system, and more particularly, to a memory system and an operating method thereof.

2. Description of the Related Art

The computer environment paradigm has shifted to ubiquitous computing systems that can be used anytime and anywhere. As such, the use of portable electronic devices such as mobile phones, digital cameras, and notebook computers has rapidly increased. These portable electronic devices generally use a memory system having memory devices, that is, a data storage device. The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

### SUMMARY

Various embodiments are directed to a memory system which is capable of rapidly and stably processing data to a memory device maximizing the use efficiency of the memory device, and an operating method thereof.

In an embodiment, a memory system may include a memory device with a plurality of planes each including a plurality of memory blocks; and a controller suitable for storing first and second command data corresponding to first and second commands in a first and a second sub-buffer of a buffer or one or more extra page buffers among page buffers included in the plurality of planes, respectively, according to a priority information and a size information of the first and second commands, and performing first and second command operations in response to the first and second commands, respectively.

The controller may allocate first and second groups of segments to the first and second sub-buffers, respectively, according to the size information of the first and second commands.

The controller may firstly perform the first command operation of a higher priority to the second command operation. When the second group of segments is insufficient to fully store the second command data during the first command operation, the controller may store the second command data in the extra page buffers.

The controller may store in the buffer a segment allocation list indicating that the second command data are stored in the extra page buffers.

When the first command operation is completed, the controller may adjust sizes of the first and second groups of segments in order that the second group of segments is sufficient to fully store the second command data, and then allocate the adjusted second group of segments to the second sub-buffer.

The controller may move the second command data from the extra page buffers to the second sub-buffer, to which the adjusted second group of segments is allocated, and perform the second command operation.

The controller may firstly perform the first command operation of a lower priority to the second command operation. When the second group of segments is insufficient to fully store the second command data during the first command operation, the controller may store the first command data in the extra page buffers.

When the controller completes the storing of the first command data in the extra page buffer, the controller may adjust sizes of the first and second groups of segments in order that the second group of segments is sufficient to fully store the second command data, and then allocate the adjusted second group of segments to the second sub-buffer.

When the second command operation is completed, the controller may adjust sizes of the first and second groups of segments in order that the first group of segments is sufficient to fully store the first command data, and then allocate the adjusted first group of segments to the first sub-buffer.

The controller may move the first command data from the extra page buffers to the first sub-buffer, to which the adjusted first group of segments is allocated, and resume the first command operation.

In an embodiment, an operating method of a memory system including a plurality of planes each including a plurality of memory blocks may include storing first and second command data corresponding to first and second commands in a first and a second sub-buffer of a buffer or one or more extra page buffers among page buffers included in the plurality of planes, respectively, according to a priority information and a size information of the first and second commands, and performing first and second command operations in response to the first and second commands, respectively.

The storing of the first and second command data may including allocating the first and second groups of segments to the first and second sub-buffers, respectively, according to the size information of the first and second commands.

The performing of the first and second command operations may include firstly performing the first command operation of a higher priority to the second command operation. When the second group of segments is insufficient to fully store the second command data during the first command operation, the storing of the first and second command data may include storing the second command data in the extra page buffers.

The storing of the first and second command data may including storing in the buffer a segment allocation list indicating that the second command data are stored in the extra page buffers.

When the first command operation is completed, the storing of the first and second command data may include adjusting sizes of the first and second groups of segments in order that the second group of segments is sufficient to fully store the second command data, and then allocating the adjusted second group of segments to the second sub-buffer.

The storing of the first and second command data may including moving the second command data from the extra page buffers to the second sub-buffer, to which the adjusted second group of segments is allocated, and the performing of the first and second command operations may include performing the second command operation.

The performing of the first and second command operations may include firstly performing the first command operation of a lower priority to the second command operation. When the second group of segments is insufficient to fully store the second command data during the first command operation, the storing of the first and second command data may include storing the first command data in the extra page buffers.

When the storing of the first and second command data completes the storing of the first command data in the extra page buffer, the storing of the first and second command data may include adjusting sizes of the first and second groups of segments in order that the second group of segments is sufficient to fully store the second command data, and then allocating the adjusted second group of segments to the second sub-buffer.

When the second command operation is completed, the storing of the first and second command data may include adjusting sizes of the first and second groups of segments in order that the first group of segments is sufficient to fully store the first command data, and then allocating the adjusted first group of segments to the first sub-buffer.

The storing of the first and second command data may include moving the first command data from the extra page buffers to the first sub-buffer, to which the adjusted first group of segments is allocated, and the performing of the first and second command operations may include resuming the first command operation.

### BRIEF DESCRIPTION OF THE DRAWINGS

FIG. 1 is a diagram illustrating a data processing system including a memory system in accordance with an embodiment.

FIG. 2 is a diagram illustrating a memory device in a memos system.

FIG. 3 is a circuit diagram illustrating a memory block in a memory device in accordance with an embodiment.

FIGS. 4, 5, 6, 7, 8, 9, 10, and 11 are diagrams schematically illustrating a memory device.

FIG. 12 is a schematic diagram illustrating a data processing operation of a memory device in a memory system in accordance with an embodiment.

FIG. 13 is a flow chart illustrating the data processing operation of the memory system in accordance with an embodiment.

### DETAILED DESCRIPTION

Various embodiments will be described below in mere detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

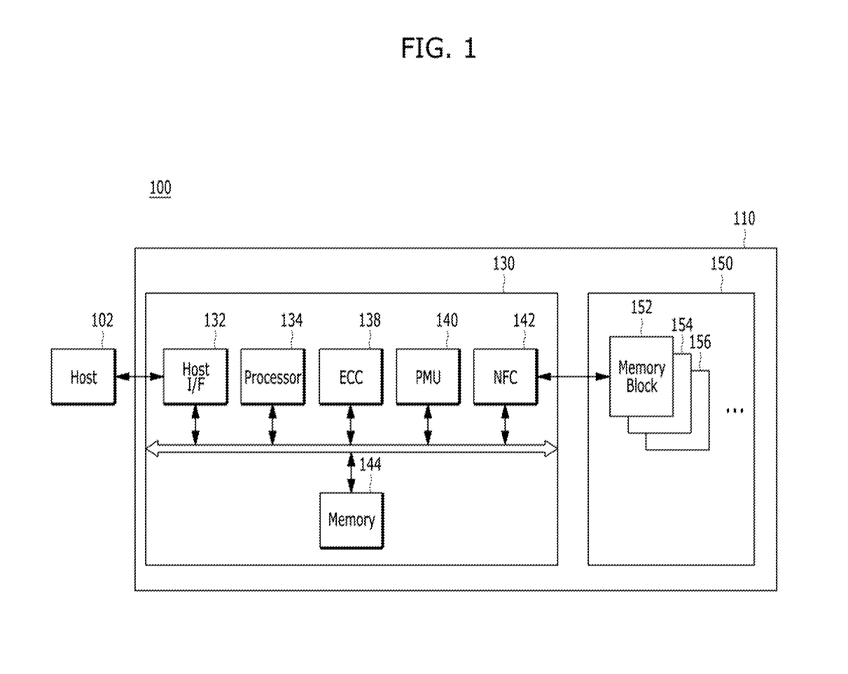

FIG. 1 is a block diagram illustrating a data processing system including a memory system in accordance with an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with various kinds of storage devices such as a solid state drive (SSD) a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

Furthermore, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, and/or one of various component elements configuring a computing system.

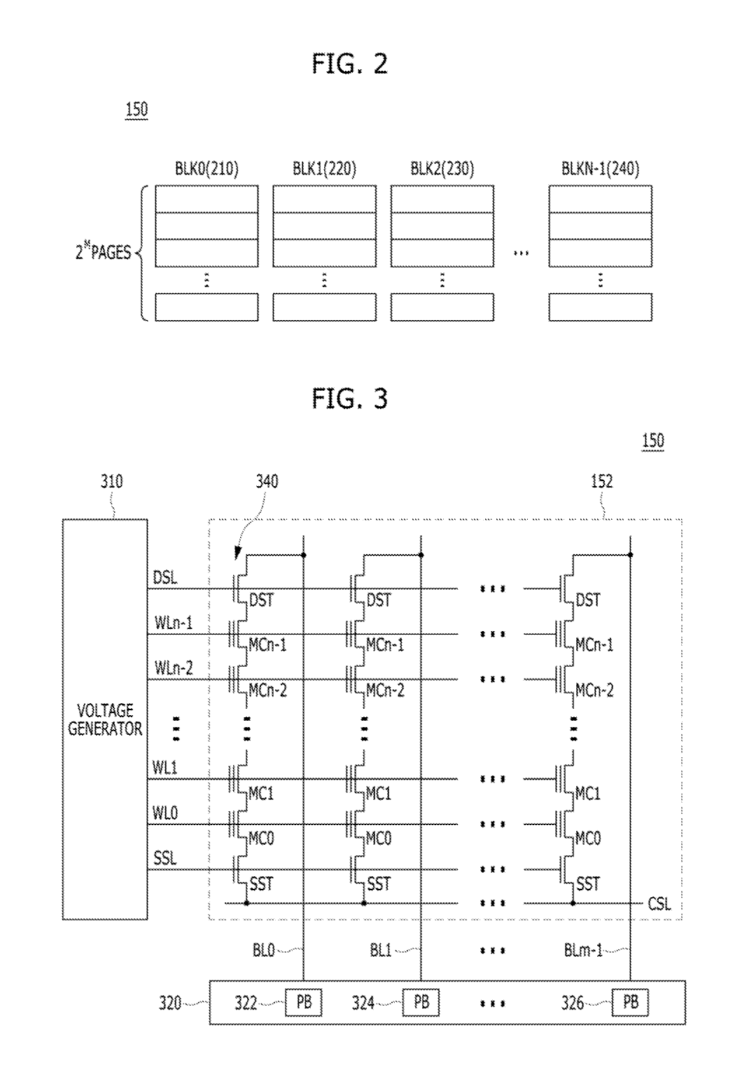

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. As such, the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and the ECC unit 138 may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130 (e.g., power for the component elements included in the controller 130).

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, as well as a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory (e.g., a NAND flash memory) a program failure may occur during the write operation (e.g., during the program operation) due to characteristics of a NAND logic function. During the bad block management, the data of the program-failed memory block or the bad memory block may be programmed into a new memory block. Also, the bad blocks seriously deteriorate the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2, the memory device 150 may include a plurality of memory blocks (e.g., zeroth to (N−1)^{th} blocks 210 to 240). Each of the plurality of memory blocks 210 to 240 may include a plurality of pages (e.g., 2^{M} number of pages (2^{M} PAGES)) to which the present invention will not be limited. Each of the plurality of pages may include a plurality of memory cells to which a plurality of word lines are electrically coupled.

The memory device 150 also includes a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data (e.g., two or more-bit data). An MLC memory block including a plurality of pages which are implemented with memory cells that are each capable of storing 3-bit data may be defined as a triple level cell (TLC) memory block.

Each memory block 210 to 240 stores the data provided from the host device 102 during a write operation, and provides stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 are electrically coupled in series between the select transistors DST and SST. The respective memory cells MC0 to MCn−1 are configured by multi-level cells (MLC) each of which stores data information of a plurality of bits. The strings 340 are electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 in accordance with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provides word line voltages (e.g., a program voltage, a read voltage and/or a pass voltage) to be supplied to respective word lines according to an operation mode and provides voltages to be supplied to bulks (e.g., well regions in which the memory cells are formed). The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 is controlled by the control circuit, and serves as a sense amplifier or a write driver according to an operation mode. During a verification/normal read operation, the read/write circuit 320 serves as a sense amplifier for reading data from the memory cell array. Also, during a program operation, the read/write circuit 320 serves as a write driver that drives bit lines according to data to be stored in the memory cell array. The read/write circuit 320 receives data to be written in the memory cell array from a buffer (not shown) during the program operation, and drives the bit lines according to the inputted data. The read/write circuit 320 may include a plurality of page buffers 322, 324 and 326 respectively corresponding to columns (or bit lines) or pairs of columns (or pairs of bit lines). A plurality of latches (not shown) may be included in each of the page buffers 322, 324 and 326.

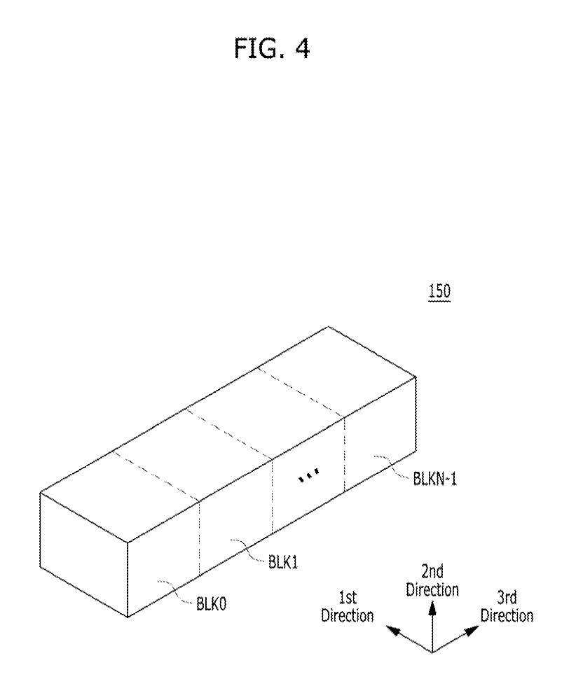

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN−1, and each of the memory blocks BLK0 to BLKN−1 may be realized in a three-dimensional (3D) structure or a vertical structure. The respective memory blocks BLK0 to BLKN−1 may include structures which extend in first to third directions (e.g., an x-axis direction, a y-axis direction and a z-axis direction).

The respective memory blocks BLK0 to BLKN−1 may include a plurality of NAND strings NS which extend in the second direction. The plurality of NAND strings NS may be provided in the first direction and the third direction. Each NAND string NS is electrically coupled to a bit line BL, at least one source select line SSL, at least one ground select line GSL, a plurality of word lines WL, at least one dummy word line DWL, and a common source line CSL. Namely, the respective memory blocks BLK0 to BLKN−1 is electrically coupled to a plurality of bit lines BL, a plurality of source select lines SSL, a plurality of ground select lines GSL, a plurality of word lines WL, a plurality of dummy word lines DWL, and a plurality of common source lines CSL.

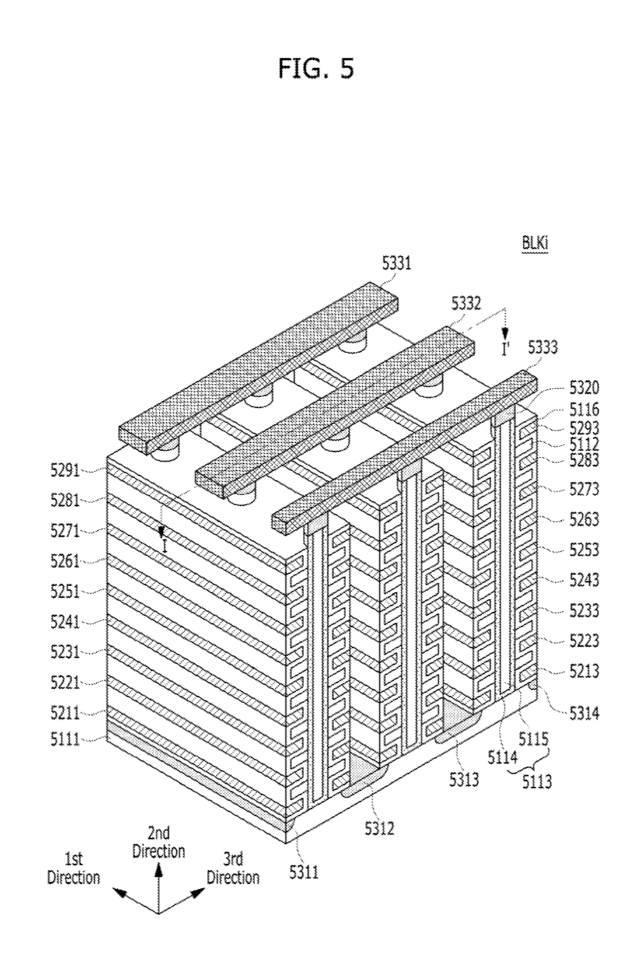

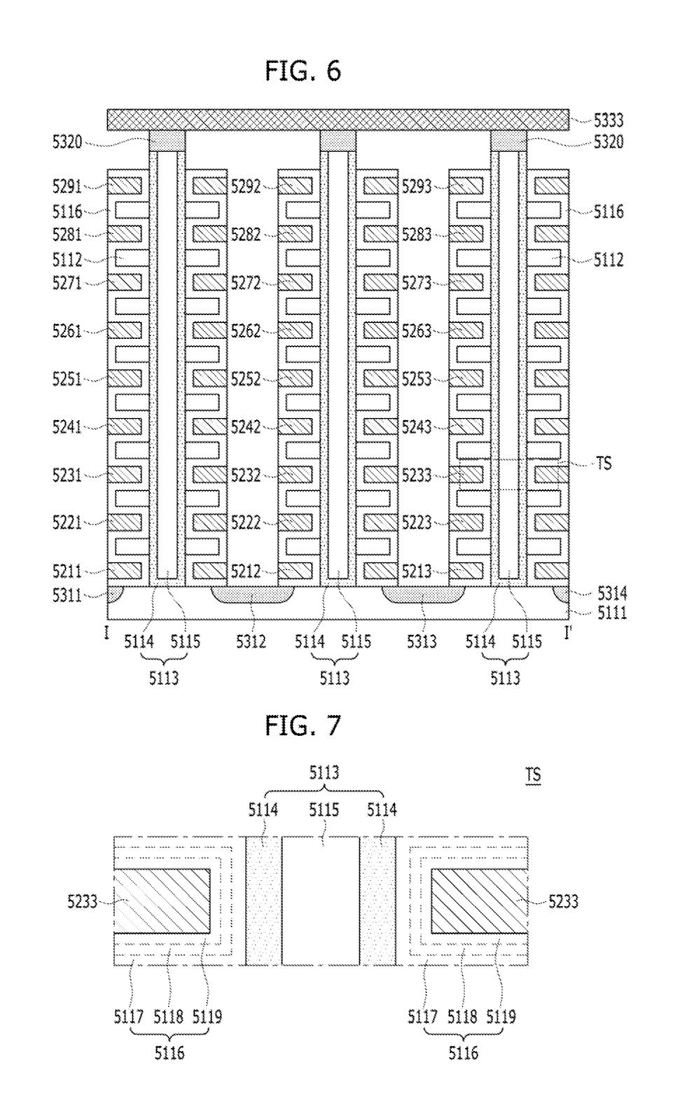

FIG. 5 is an isometric view of one BLKi of the plural memory blocks BLK0 to BLKN−1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well (e.g., a pocket p-well) and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as the structures between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed that the drains 5320 include n-type silicon, it is to be noted that the drains 5320 are not limited to being n-type silicon. For example, the width of each drain 5320 may be greater than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer (e.g., an aluminum oxide layer, a hafnium oxide layer, etc.) that has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111 (e.g., the second direction) and may serve as a NAND flash memory block (e.g., of a charge capturing type memory) to which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

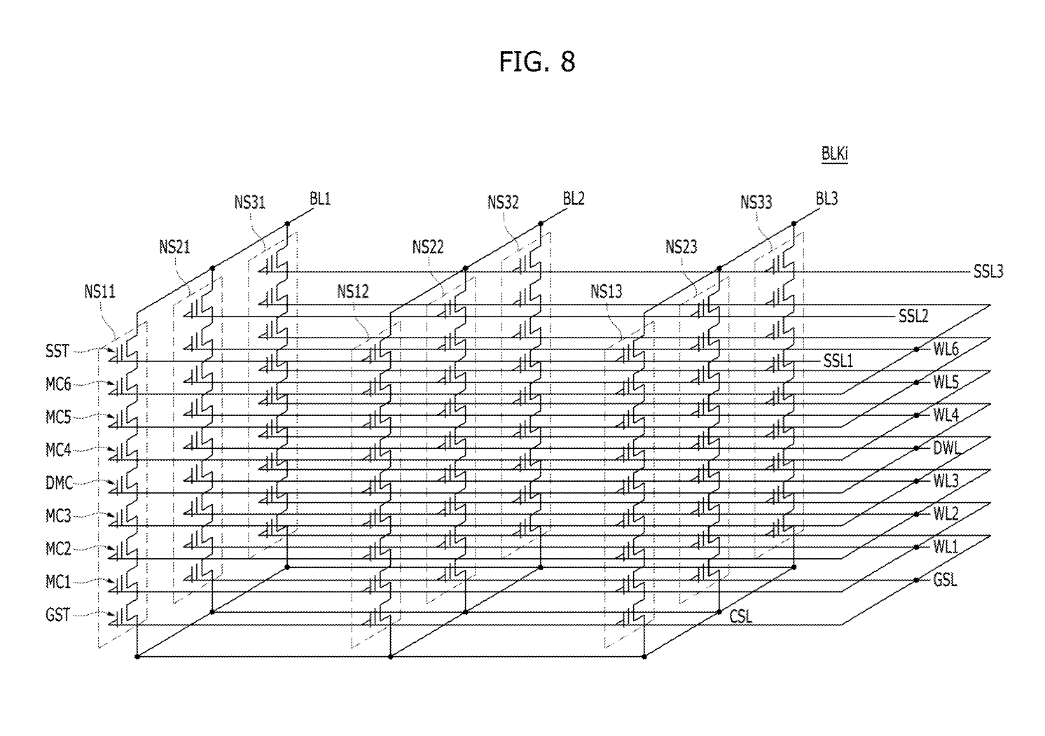

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS are defined by units of rows and columns and NAND strings NS which are electrically coupled to one bit line may form one column. The NAND strings NS11 to NS31 which are electrically coupled to the first bit line BL1 correspond to a first column, the NAND strings NS12 to NS32 which are electrically coupled to the second bit line BL2 correspond to a second column, and the NAND strings NS13 to NS33 which are electrically coupled to the third bit line BL3 correspond to a third column. NAND strings NS which are electrically coupled to one source select line SSL form one row. The NAND strings NS11 to NS13 which are electrically coupled to a first source select line SSL1 form a first row, the NAND strings NS21 to NS23 which are electrically coupled to a second source select line SSL2 form a second row, and the NAND strings NS31 to NS33 which are electrically coupled to a third source select line SSL3 form a third row.

In each NAND string NS, a height is defined. In each NAND string NS, the height of a memory cell MC1 adjacent to the ground select transistor GST has a value ‘1’. In each NAND string NS, the height of a memory cell increases as the memory cell gets closer to the source select transistor SST when measured from the substrate 5111. In each NAND string NS, the height of a memory cell MC6 adjacent to the source select transistor SST is 7.

The source select transistors SST of the NAND strings NS in the same row share the source select line SSL. The source select transistors SST of the NAND strings NS in different rows be respectively electrically coupled to the different source select lines SSL1, SSL2 and SSL3.

The memory cells at the same height in the NAND strings NS in the same row share a word line WL. That is, at the same height, the word lines WL electrically coupled to the memory cells MC of the NAND strings NS in different rows are electrically coupled. Dummy memory cells DMC at the same height in the NAND strings NS of the same row share a dummy word line DWL. Namely, at the same height or level, the dummy word lines DWL electrically coupled to the dummy memory cells DMC of the NAND strings NS in different rows are electrically coupled.

The word lines WL or the dummy word lines DWL located at the same level or height or layer are electrically coupled with one another at layers where the conductive materials 5211 to 5291, 5212 to 5292 and 5213 to 5293 which extend in the first direction are provided. The conductive materials 5211 to 5291, 5212 to 5292 and 5213 to 5293 which extend in the first direction are electrically coupled in common to upper layers through contacts. At the upper layers, the conductive materials 5211 to 5291, 5212 to 5292 and 5213 to 5293 which extend in the first direction are electrically coupled. In other words, the ground select transistors GST of the NAND strings NS in the same row share the ground select line GSL. Further, the ground select transistors GST of the NAND strings NS in different rows share the ground select line GSL. That is, the NAND strings NS11 to NS13, NS21 to NS23 and NS31 to NS33 are electrically coupled to the ground select line GSL.

The common source line CSL is electrically coupled to the NAND strings NS. Over the active regions and over the substrate 5111, the first to fourth doping regions 5311 to 5314 are electrically coupled. The first to fourth doping regions 5311 to 5314 are electrically coupled to an upper layer through contacts and, at the upper layer, the first to fourth doping regions 5311 to 5314 are electrically coupled.

As shown in FIG. 8, the word lines WL of the same height or level are electrically coupled. Accordingly, when a word line WL at a specific height is selected, all NAND strings NS which are electrically coupled to the word line WL are selected. The NAND strings NS in different rows are electrically coupled to different source select lines SSL. Accordingly, among the NAND strings NS electrically coupled to the same word line WL, by selecting one of the source select lines SSL1 to SSL3, the NAND strings NS in the unselected rows are electrically isolated from the bit lines BL1 to BL3. In other words, by selecting one of the source select lines SSL1 to SSL3, a row of NAND strings NS is selected. Moreover, by selecting one of the bit lines BL1 to BL3, the NAND strings NS in the selected rows are selected in units of columns.

In each NAND string NS, a dummy memory cell DMC is provided. In FIG. 8, the dummy memory cell DMC is provided between a third memory cell MC3 and a fourth memory cell MC4 in each NAND string NS. That is, first to third memory cells MC1 to MC3 are provided between the dummy memory cell DMC and the ground select transistor GST. Fourth to sixth memory cells MC4 to MC6 are provided between the dummy memory cell DMC and the source select transistor SST. The memory cells MC of each NAND string NS are divided into memory cell groups by the dummy memory cell DMC. In the divided memory cell groups, memory cells (e.g., MC1 to MC3) adjacent to the ground select transistor GST may be referred to as a lower memory cell group, and memory cells, for example, MC4 to MC6, adjacent to the string select transistor SST may be referred to as an upper memory cell group.

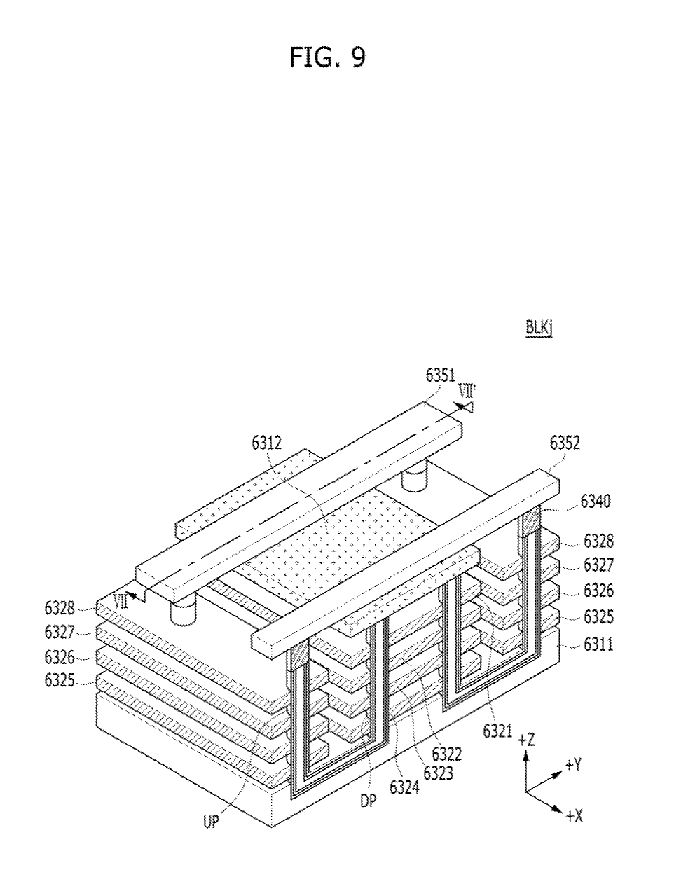

Herein, detailed descriptions will be made with reference to FIGS. 9 to 11, which show the memory device in the memory system in accordance with an embodiment implemented with a three-dimensional (3D) nonvolatile memory device different from the first structure.

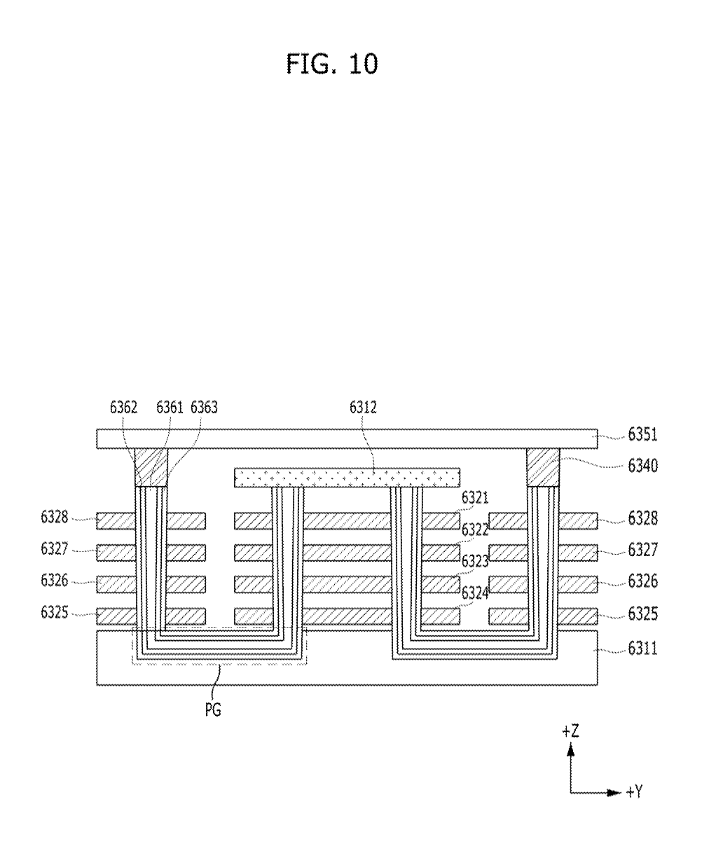

FIG. 9 is an isometric view schematically illustrating the memory device implemented with the three-dimensional (3D) nonvolatile memory device and showing a memory block BLKj of the plurality of memory blocks of FIG. 4. FIG. 10 is a cross-sectional view illustrating the memory block BLKj taken along the line VII-VII′ of FIG. 9.

Referring to FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well (e.g., a pocket p-well) and include an n-type well which surrounds the p-type well. While it is assumed in the embodiment that the substrate 6311 is p-type silicon, it is to be noted that the substrate 6311 is not limited to being p-type silicon.

First to fourth conductive materials 6321 to 6324 which extend in the x-axis direction and the y-axis direction may be provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

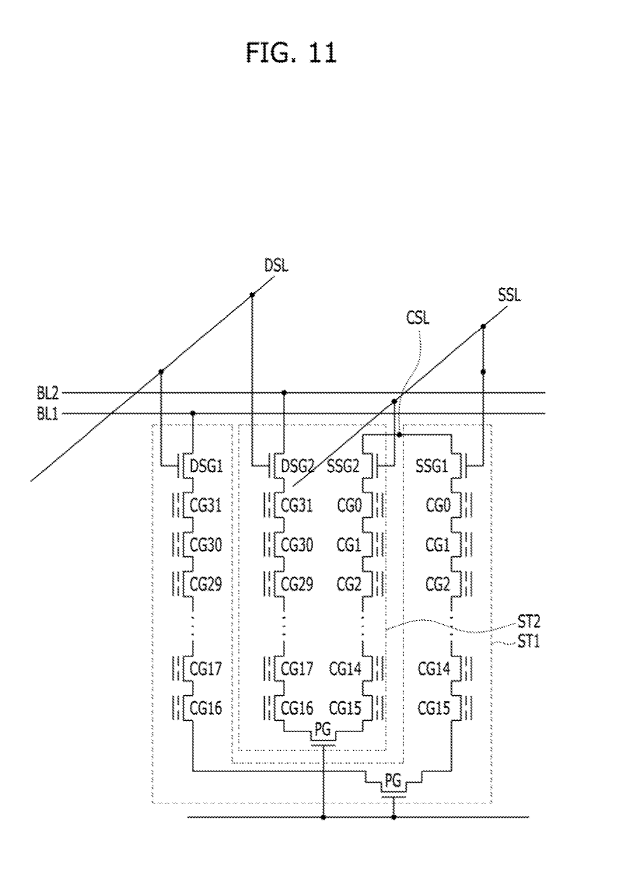

FIG. 11 is a circuit diagram illustrating the equivalent circuit of the memory block BLKj having the second structure as described above with reference to FIGS. 9 and 10. A first string and a second string, which form a pair in the memory block BLKj in the second structure are shown.

Referring to FIG. 11, in the memory block BLKj having the second structure among the plurality of blocks of the memory device 150, cell strings, each of which is implemented with one upper string and one lower string electrically coupled through the pipe gate PG as described above with reference to FIGS. 9 and 10, is provided in such a way as to define a plurality of pairs.

In the certain memory block BLKj having the second structure, memory cells CG0 to CG31 stacked along a first channel CH1 (not shown) (e.g., at least one source select gate SSG1 and at least one drain select gate DSG1) form a first string ST1, and memory cells CG0 to CG31 stacked along a second channel CH2 (not shown) (e.g., at least one source select gate SSG2 and at least one drain select gate DSG2) form a second string ST2.

The first string ST1 and the second string ST2 are electrically coupled to the same drain select line DSL and the same source select line SSL. The first string ST1 is electrically coupled to a first bit line BL1, and the second string ST2 is electrically coupled to a second bit line BL2.

While it is described in FIG. 11 that the first string ST1 and the second string ST2 are electrically coupled to the same drain select line DSL and the same source select line SSL, it is contemplated that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it is contemplated that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

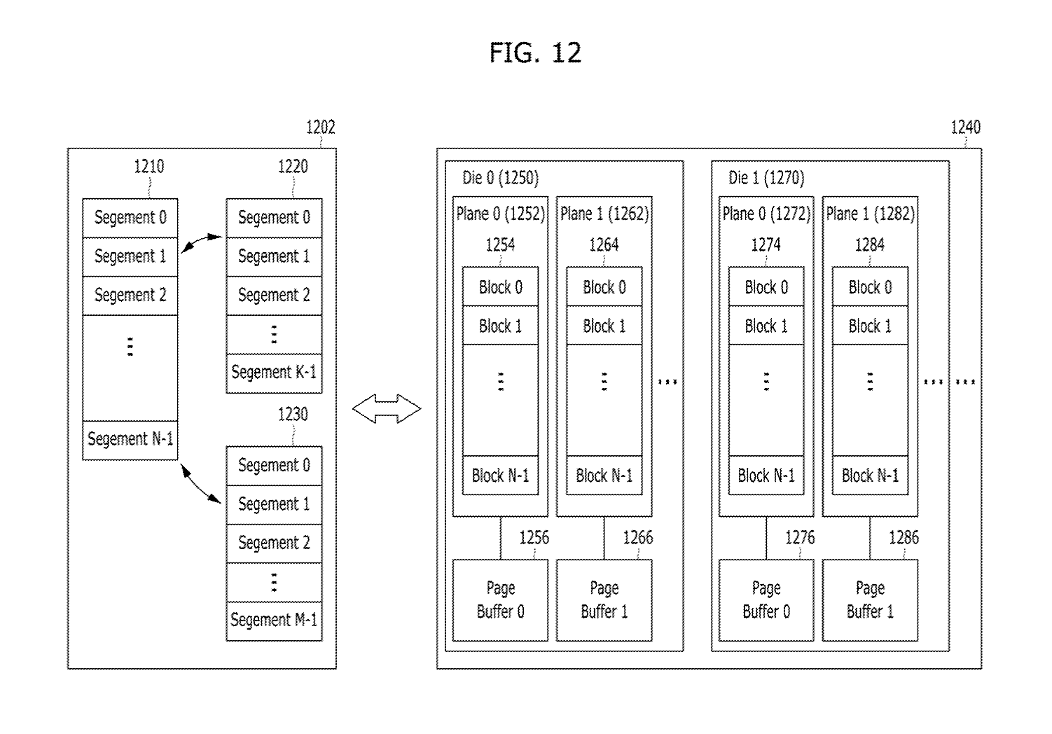

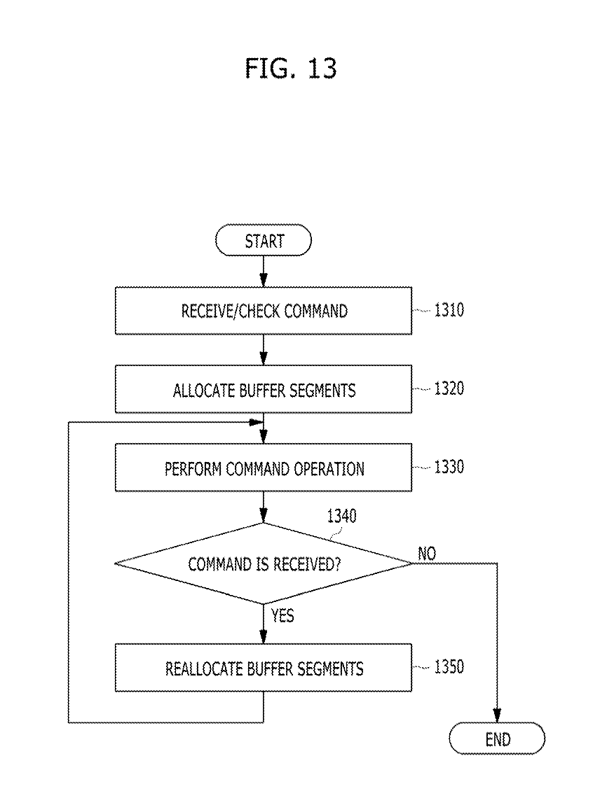

Hereafter, a data processing operation for the memory device 150 in the memory system 110 in accordance with an embodiment of the present invention will be described in detail with reference to FIGS. 12 to 13.

FIG. 12 is a schematic diagram illustrating a data processing operation of the memory device 150 in memory system 110 in accordance with an embodiment.

For example, the memory system 110 stores read/write data corresponding to a read/write command provided from the host 102 in a buffer/cache included in the memory 144 of the controller 130, and then the memory system 110 reads/writes the data stored in the buffer/cache from or to a plurality of memory blocks included in the memory device 150. The memory system 110 dynamically allocates the buffer/cache according to the size of the read/write data, stores the read/write data in the dynamically allocated buffer/cache, and performs a read/write operation on the memory device 150.

The case in which a data processing operation in the memory system is performed by the controller 130 will be taken as an example. As described above, however, the processor 134 included in the controller 130 may perform the data processing operation.

The read/write data may be stored in the buffer/case included in the memory 144 of the controller 130. The buffer/cache may be divided into a plurality of segments having a predetermined size. A size of the read/write data size or a chunk size may be checked to dynamically allocate the segments to a read/write buffer, and the read/write data may be stored in the read/write buffer to which the segments are dynamically allocated. Then, a read/write operation may be performed on the memory device 50.

The read/write command may include priority information on the read/write operation and size information on the size of the read/write data corresponding to the read/write command. According to the size information of the read/write data or a command data, the segments may be allocated to the read/write buffer. Furthermore, according to the priority information of the read/write operation or a command operation, the segments may be preferentially allocated to the read/write buffer.

In an embodiment, segments may be preferentially allocated to the read/write buffer for the read/write operation having a high priority. Then, when segments to be allocated to the read/write buffer for the read/write operation having a low priority have insufficient storage space to store all of the command data, the command data for the command operation having the low priority may be stored in the plurality of page buffers 322, 324 and 326 (indicated by reference numbers 1256, 1266, 1276, and 1286 in FIG. 12) included in the read/write circuit 320 of a plurality of chips or dies. The plurality of chips or dies are included in the memory device 150.

Furthermore, when the command operation having the high priority is completed, the segments allocated to the read/write buffer for the operation having the high priority may be re-allocated to the read/write buffer for the operation having the low priority, and the command data stored in the plurality of page buffers 1256, 1266, 1276, and 1286 of the memory device 150 may be moved to the read/write buffer to which the segments are re-allocated. Then, a command operation of the low priority may be performed on the memory device 150.

Referring to FIG. 12, the controller 130 may store write data in the buffer 1202 included in the memory 144 of the controller 130, and program or write the write data stored in the buffer 1202 to a plurality of pages of a plurality of memory blocks included in a memory device 150. Furthermore, the controller 130 may read data from the plurality of pages, store the read data in the buffer 1202, and then provide the data stored in the buffer 1202 to the host 102.

The controller 130 may check the size of the command data or a chunk size. According to the chunk size, the controller 130 may allocate a plurality of segments 1210 divided in the buffer 1202 to a first sub-buffer 1220 or second sub-buffer 1230, and perform the command operation according to the read/write command provided from the host 102.

The controller 130 may check the priority of the command operation corresponding to the read/write command (e.g., a command priority) and check the size of the command data (e.g., the chunk size).

The read/write command may include the priority information of the command operation. For example, the command may include priority information between a command operation corresponding to a command at the current time point and a command operation corresponding to a command at the previous time point. The priority information may be configured in the form of a context or flag. The priority information included in the command may indicate that the current command operation has a higher or lower priority to the previous command operation. For example, when the current command operation has a higher priority to the previous command operation, the context or flag of the current command may be set to ‘1’. Furthermore, when the current command operation has a lower priority to the previous command operation, the context or flag of the current command may be set to ‘0’.

The priority of the command operation may be determined by command importance based on the type of the command operation or command throughput based on a required time of the command operation. For example, when a first command operation of a first time point has higher command importance or command throughput than a second command operation of a second time point, the first command operation may have a higher priority to the second command operation. The command operation of the higher priority may be performed prior to the command operation of the lower priority. For example, when the first command operation is a read operation and the second command operation is a write operation, the read operation may be preferentially performed.

As described above, the read/write command may contain the size information of the command data. The size information may be configured in the form of a context. The size of the command data may be represented by the number of unit chunks of the command data.

The controller 130 may check the priority information and size information included in the command, and allocate the segments 1210 to the sub-buffers 1220 and 1230 for storing the command data according to the priority information and size information.

When receiving the command from the host 102 at an arbitrary time point t0, the controller 130 may check the priority information and size information of the command from the command. Hereafter, the command, the command operation, and the command data of the time point t0 will be referred to as a first time command, a first time command operation, and a first time command data, respectively.

The controller 130 may allocate a part of the segments 1210 of the buffer 1202 to the first sub-buffer 1220 for the first time command operation. The buffer 1202 includes the plurality of segments 1210 (e.g., N segments (Segment0 to Segment(N−1)) and K segments (Segment0 to Segment(K−1) of the N segments Segment0 to Segment(N−1))) that are allocated to the first sub-buffer 1220 for the first time command operation according to the size of the first time command data. The controller 130 may check the size information of the first time command data included in the first time command.

Each of the segments 1210 of the buffer 1202 may have a size corresponding to the unit chunk size of the command data. The unit chunk size may be an integer multiple of the unit segment size. For example, when the unit chunk size is 2K, the unit segment size of the segments 1210 of the buffer 1202 may be 1K or 2K.

For example, when the first time command is the write command, the controller 130 may perform the write operation to store the write data in the first sub-buffer 1220, and then write the write data stored in the first sub-buffer 1220 to pages of the plurality of blocks included in the memory device 150.

As described above, the memory device 150 may include a plurality of dies, for example, a die 0(1250) and a die 1(1270). The plurality of dies 1250 and 1270 may include a plurality of planes. That is, the die 0(1250) may include planes 0(1252) and 1(1262) and page buffers 0(1256) and 1(1266) corresponding to the planes 0(1252) and 1(1262), respectively, and the die 1(1270) may include planes 0(1272) and 1(1282) and page buffers 0(1276) and 1(1286) corresponding to the planes 0(1272) and 1(1282), respectively. Each of the planes 0(1252 and 1272) and the second planes 1(1262 and 1282) of the die 0(1250) and the die 1(1270) may include a plurality of blocks Block0 to Block(N−1).

Hereafter, the command provided from the host 102 at a second time point after the first time point, the command operation, and the command data of the second time point will be referred to as a second time command, a second time command operation, and a second time command data, respectively. When the second time command is provided at the second time point while the controller 130 performs the first time command operation, the controller 130 may check the priority information and size information of the second command from the second command.

Hereafter, the case in which the second time command operation has a lower priority to the first time command operation will be described in detail. Then, the case in which the second time command operation has a higher priority to the first time command operation will be described in detail.

In the case that the second time command has a lower priority than the first time command, the controller 130 checks that the second time command operation has a lower priority to the first time command operation through the priority information contained in the second time command, and the controller 130 may perform the second time command operation after the first time command operation is completed.

The controller 130 may allocate K segments Segment0 to Segment(K−1) of the segments 1210 to the first sub-buffer 1220 for the first time command operation, store the first time command data in the first sub-buffer 1220 to which K segments Segment0 to Segment(K−1) are allocated, and perform the first time command operation on the memory device 150.

Furthermore, the controller 130 may check the size of the second time command data, and allocate M segments Segment0 to Segment(M−1) of the segments 1210 to the second sub-buffer 1230 for the second command operation. The controller 130 may check the size of the second time command data or the unit chunk number of the second time command data, and then allocate M segments Segment0 to Segment(M−1) corresponding to the unit chunk number to the second sub-buffer 1230 for the second time command operation.

In this case, since the controller 130 has allocated the K segments Segment0 to Segment(K−1) to the first sub-buffer 1220 for the first command operation having the higher priority, the segments may not be allocated to the second sub-buffer 1230 for the second time command operation when the number of remaining non-allocated (N−K) ones of the segments 1210 is less than the number of M segments Segment0 to Segment(M−1) which need to be allocated to the second sub-buffer 1230 for the second time command operation having the lower priority.

At this time, since the second time command operation has a lower priority to the first time command operation, the controller 130 may not store the second time command data in the buffer 1202, but in arbitrary page buffers among the page buffers 1256, 1266, 1276, and 1286 formed in the respective planes 1252, 1262, 1272, and 1282 of the memory device 150.

The controller 130 may check the size of extra page buffers which can serve to store the second command data in the page buffers 1256, 1266, 1276, and 1286. Then, the controller 130 may store the second time command data in the extra page buffers having the same size as M segments Segment0 to Segment(M−1) required to be allocated for the second time command operation having the lower priority.

The case in which the extra page buffers in the page buffers 1256, 1266, 1276, and 1286 of the memory device 150 are included in the page buffer 0(1256) and the page buffer 1(1266) corresponding to the plane 0(1252) and the plane 1(1262) of the die 0(1250) will be taken as an example. The extra page buffer of the page buffer 0(1256) will be referred to as a first extra page buffer, and the extra page buffer of the page buffer 1(1266) will be referred to as a second extra page buffer.

The first and second extra page buffers in the page buffer 0(1256) and the page buffer 1(1266) may not be used during the command operation on the plane 0(1252) and the plane 1(1262) of the die 0(1250). The controller 130 may use the first and second extra page buffers as the second sub-buffer 1230. That is, the first and second extra page buffers of the page buffer 0(1256) and the page buffer 1(1266) may serve as the second sub-buffer 1230 having the size of M segments Segment0 to Segment(M−1) required to be allocated for the second time command operation having the lower priority.

At this time, the controller 130 may store a segment allocation list in the buffer 1202 of the memory 144. The segment allocation list may contain information indicating that the second time command data are stored in the first and second extra page buffer of the page buffer 0(1256) and the page buffer 1(1266). The segment allocation list may further contain information indicating that the first time command data are stored in the first sub-buffer 1220 of segments Segment0 to Segment(K−1).

In this way, the controller 130 may store the second time command data for the second time command operation having the lower priority in the first and second extra page buffers of the page buffer 0(1256) and the page buffer 1(1266). When the first time command operation having the higher priority is completed, the controller 130 may return K segments Segment0 to Segment(K−1), which have been allocated to the first sub-buffer 1220 for the first time command operation, to non-allocated segments in the buffer 1202. Thus, N segments Segment0 to Segment(N−1) may exist as non-allocated segments in the buffer 1202.

Furthermore, the controller 130 may allocate M segments Segment0 to Segment(M−1) among the N non-allocated segments Segment0 to Segment (N−1) of the buffer 1202 to the second sub-buffer 1230, move the second time command data stored in the first and second extra page buffers of the page buffer 0(1256) and the page buffer 1(1266) to the second sub-buffer 1230 to which M segments Segment0 to Segment(M−1) are allocated, and perform the second time command operation on the memory device 150.

In the case that the second time command has a higher priority to the first time command, the controller 130 may check that the second time command operation has a higher priority to the first time command operation, through the priority information contained in the second time command. Thus, the second time command operation may be performed prior to the first time command operation. The controller 130 may stop performing the first time command operation, and preferentially perform the second time command operation. After completing the second time command operation, the controller 130 may resume the first time command operation.

At this time, since the K segments Segment0 to Segment(K−1) among the N segments Segment0 to Segment(N−1) of the buffer 1202 are allocated to the first sub-buffer 1220 for the first time command operation, the segments may not be allocated to the second sub-buffer 1230 for the second time command operation when the number of remaining non-allocated (N−K) segments 1210 is less than the number of M segments Segment0 to Segment(M−1) which need to be allocated to the second sub-buffer 1230 for the second time command operation having the higher priority.

Therefore, in order to allocate M segments Segment0 to Segment(M−1) to the second sub-buffer 1230 for the second time command operation having the higher priority, the controller 130 may move the first command data stored in the first sub-buffer 1220 into arbitrary page buffers of the page buffers 1256, 1266, 1276, and 1286 included in the respective planes 1252, 1262, 1272, and 1282 of the memory device 150. The controller 130 may check the size of extra page buffers which can serve to store the first command data in the page buffers 1256, 1266, 1276, and 1286. Then, the controller 130 may store the first time command data in the extra page buffers having the same size as K segments Segment0 to Segment(K−1) required to be allocated for the first time command operation having the lower priority.

The case in which extra page buffers in the page buffers 1272, 1266, 1276, and 1286 of the memory device 150 are included in the page buffer 0(1276) and the page buffer 1(1286) corresponding to the plane 0(1272) and the plane 1(1282) of the die 1(1270) will be taken as an example. The extra page buffer of the page buffer 0(1276) will be referred to as a third extra page buffer, and the extra page buffer of the page buffer 1(1286) will be referred to as a fourth extra page buffer.

The third and fourth extra page buffers in the page buffer 0(1276) and the page buffer 1(1286) may not be used during the command operation on the plane 0(1276) and the plane 1(1286) of the die 1(1270). The controller 130 may use the third and fourth extra page buffers as the first sub-buffer 1220. That is, the third and fourth extra page buffers of the page buffer 0(1276) and the page buffer 1(1286) may serve as the first sub-buffer 1220 having the size of K segments Segment0 to Segment(K−1) required to be allocated for the first time command operation having the lower priority.

At this time, the controller 130 may store a segment allocation list in the buffer 1202 of the memory 44. The segment allocation list may contain information indicating that the first time command data are stored in the third and fourth extra page buffers of the page buffer 0(1276) and the page buffer 1(1286). At this time, the segment allocation list may further contain information indicating that the second time command data are stored in the second sub-buffer 1230 of M segments Segment0 to Segment(M−1).

That is, the controller 130 may move the low-priority first command data stored in the K segments Segment0 to Segment(K−1) of the buffer 1202 into the third and fourth extra page buffers of the page buffer 0(1276) and the page buffer 1(1276), and then return the K segments Segment0 to Segment(K−1), which have been allocated to the first sub-buffer 1220 for the first time command operation, to non-allocated segments. Thus, N segments Segment0 to Segment(N−1) may exist as non-allocated segments in the buffer 1202.

Furthermore, the controller 130 may allocate M segments Segment0 to Segment(M−1) among the N non-allocated segments Segment0 to Segment (N−1) of the buffer 1202 to the second sub-buffer 1230, store the second time command data in the second sub-buffer 1230 to which M segments Segment0 to Segment(M−1) are allocated, and perform the second time command operation on the memory device 150.

In this way, the controller 130 may resume the first time command operation having the lower priority after completing the second time command operation having the higher priority. That is, the controller 130 may return the M segments Segment0 to Segment(M−1), which have been allocated to the second sub-buffer 1230 for the second command operation, to non-allocated segments, and then allocate K segments Segment0 to Segment(K−1), among the N non-allocated segments Segment0 to Segment(N−1) existing in the buffer 1202, to the first sub-buffer 1220. The controller 130 may move the first time command data stored in the third and fourth extra page buffers of the page buffer 0(1276) and the page buffer 1(1286) to the first sub-buffer 1220 to which K segments Segment0 to Segment(K−1) are allocated, and perform the first time command operation on the memory device 150.

In the present embodiment, for the command operation in response to the command, the controller 130 may check the priority information of the command operation and the size information of the command data from the command, and then allocate a part of the segments 1210 to a sub-buffer for a command operation having a high priority. Furthermore, the controller 130 may store command data corresponding to the command having the high priority to the sub-buffer to which the segments are allocated, and perform the command operation having the high priority with the memory device 150.

When segments to be allocated to the buffer 1202 for the command operation having a low priority have insufficient storage space to store all of the command data, the command data for the command operation having the low priority may be stored in the extra page buffers of the plurality of page buffers 1256, 1266, 1276, and 1286 included in the memory device 150.

When the high-priority command operation is completed, the segments allocated to the read/write buffer for the operation having the high priority may be re-allocated to the buffer 1202 of the memory 114 for the operation having the low priority, and the command data stored in the extra page buffers of the plurality of page buffers 1256, 1266, 1276, and 1286 of the memory device 150 may be moved to the buffer 1202 of the memory 114 to which the segments are re-allocated. Then, the command operation of the low priority may be performed on the memory device 150.

FIG. 13 is a flow chart illustrating the data processing operation of the memory system 110 in accordance with an embodiment.

Referring to FIG. 13, the memory system 110 receives the command from the host, and checks the command operation corresponding to the command and the priority information of the command operation and the size information of the command data, which are contained in the command, at step S1310. As described above, the command may contain the priority information of the command operation and the size information of the command data. Since the priority information and the size information have been already described above, the detailed descriptions thereof are omitted herein.

At step S1320, the memory system 110 allocates the segments of the buffer 1220 included in the memory 144 of the controller 130 to the first and second sub-buffers 1220 and 1230 for the command operation based on the priority information and the size information.

At step S1330, the memory system stores the command data corresponding to the command operation in the first and second sub-buffers 1220 and 1230 to which the segments are allocated, and performs the command operation with the memory device 150.

When a new command is received at step S1340 while the command operation is performed with the memory device, the memory system 110 checks the new command operation corresponding to the new command and the priority information of the new command operation and the size information of the new command data, which are contained in the new command, and re-allocates the plurality of segments to the first and second sub-buffers 1220 and 1230 according to the priority information and the size information of the new command.

At step S1330, according to the priority information of the command operation of the new command, the memory system 110 performs the command operation of the previous command and the command operation of the new command with the memory device 150.

When the command operation of the new command has a higher priority or lower priority to the command operation of the previous command, the memory system allocates the segments of the buffer 1220 to the first and second sub-buffers 1220 and 1230 for performing the command operation of the new command and allocates the segments of the buffer 1220 to the first and second sub-buffers 1220 and 1230 for performing the command operation of the previous command. Then, the memory system 110 stores command data into the allocated the first and second sub-buffers 1220 and 1230, and performs the command operations with the memory device 150. Since this operation of the memory system has been already described above with reference to FIG. 12, the detailed descriptions thereof are omitted herein.

In accordance with the embodiments of the present invention, the memory system and the operating method thereof can rapidly and stably process data to the memory device while maximizing the use efficiency of the memory device.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device comprising a plurality of planes each including a plurality of memory blocks; and
a controller suitable for storing first and second command data corresponding to first and second commands in a first and a second sub-buffer of a buffer or one or more extra page buffers among page buffers included in the plurality of planes, respectively, according to a priority information and a size information of the first and second commands, and performing first and second command operations in response to the first and second commands, respectively.

2. The memory system of claim 1, wherein the controller allocates first and second groups of segments to the first and second sub-buffers, respectively, according to the size information of the first and second commands.

3. The memory system of claim 2,
wherein the controller firstly performs the first command operation of a higher priority to the second command operation, and
wherein, when the second group of segments are insufficient to fully store the second command data during the first command operation, the controller stores the second command data in the extra page buffers.

4. The memory system of claim 3, wherein the controller stores in the buffer a segment allocation list indicating that the second command data are stored in the extra page buffers.

5. The memory system of claim 3, wherein, when the first command operation is completed, the controller adjusts sizes of the first and second groups of segments such that the second group of segments is sufficient to fully store the second command data, and then allocates the adjusted second group of segments to the second sub-buffer.

6. The memory system of claim 5, wherein the controller moves the second command data from the extra page buffers to the second sub-buffer to which the adjusted second group of segments is allocated, and performs the second command operation.

7. The memory system of claim 2,
wherein the controller firstly performs the first command operation of a lower priority to the second command operation, and
wherein when the second group of segments is insufficient to fully store the second command data during the first command operation, the controller stores the first command data in the extra page buffers.

8. The memory system of claim 7, wherein, when the controller completes the storing of the first command data in the extra page buffer, the controller adjusts sizes of the first and second groups of segments in order that the second group of segments is sufficient to fully store the second command data, and then allocates the adjusted second group of segments to the second sub-buffer.

9. The memory system of claim 8, wherein, when the second command operation is completed, the controller adjusts sizes of the first and second groups of segments in order that the first group of segments is sufficient to fully store the first command data, and then allocates the adjusted first group of segments to the first sub-buffer.

10. The memory system of claim 9, wherein the controller moves the first command data from the extra page buffers to the first sub-buffer, to which the adjusted first group of segments is allocated, and resumes the first command operation.

11. An operating method of a memory system including a plurality of planes each including a plurality of memory blocks, comprising:
storing first and second command data corresponding to first and second commands in a first and a second sub-buffer of a buffer or one or more extra page buffers among page buffers included in the plurality of planes, respectively, according to a priority information and a size information of the first and second commands, and
performing first and second command operations in response to the first and second commands, respectively.

12. The operating method of claim 11, wherein the storing of the first and second command data allocates first and second groups of segments to the first and second sub-buffers, respectively, according to the size information of the first and second commands.

13. The operating method of claim 12,
wherein the performing of the first and second command operations includes firstly performing the first command operation of a higher priority to the second command operation, and
wherein, when the second group of segments is insufficient to fully store the second command data during the first command operation, the storing of the first and second command data includes storing the second command data in the extra page buffers.

14. The operating method of claim 13, wherein the storing of the first and second command data includes storing in the buffer a segment allocation list indicating that the second command data are stored in the extra page buffers.

15. The operating method of claim 13, when the first command operation is completed, the storing of the first and second command data includes adjusting sizes of the first and second groups of segments in order that the second group of segments is sufficient to fully store the second command data, and then allocating the adjusted second group of segments to the second sub-buffer.

16. The operating method of claim 15, wherein the storing of the first and second command data includes moving the second command data from the extra page buffers to the second sub-buffer, to which the adjusted second group of segments is allocated, and the performing of the first and second command operations includes performing the second command operation.

17. The operating method of claim 12,
wherein the performing of the first and second command operations includes firstly performing the first command operation of a lower priority to the second command operation, and
wherein when the second group of segments is insufficient to fully store the second command data during the first command operation, the storing of the first and second command data includes storing the first command data in the extra page buffers.

18. The operating method of claim 17, wherein, when the storing of the first and second command data completes the storing of the first command data in the extra page buffer, the storing of the first and second command data includes adjusting sizes of the first and second groups of segments in order that the second group of segments is sufficient to fully store the second command data, and then allocating the adjusted second group of segments to the second sub-buffer.

19. The memory system of claim 18, wherein, when the second command operation is completed, the storing of the first and second command data includes adjusting sizes of the first and second groups of segments in order that the first group of segments is sufficient to fully store the first command data, and then allocating the adjusted first group of segments to the first sub-buffer.

20. The operating method of claim 19, wherein the storing of the first and second command data includes moving the first command data from the extra page buffers to the first sub-buffer, to which the adjusted first group of segments is allocated, and the performing of the first and second command operations includes resuming the first command operation.
